(19) United States
(12) Patent Application Publication
(10) Pub. No.: US 2007/0016935 A1
(43) Pub. Date: Jan. 18, 2007

(54) Methods and apparatus for transmitting and receiving television signals

(76) Inventors: Ralph Brookfield, Isleworth (GB); Danny Payea, Isleworth (GB); Michael Somes, Isleworth (GB); Xavier Williame, Isleworth (GB); Walter Robin Francis Worboys, Isleworth (GB)

Correspondence Address: ROTHWELL, FIGG, ERNST & MANBECK, P.C., 1425 K STREET, N.W., SUITE 800, WASHINGTON, DC, 20005, US

(21) Appl. No.: 10/542,985

(22) PCT Filed: Jan. 22, 2004
(86) PCT No.: PCT/GB04/00267

§ 371 Date: Sep. 22, 2006

(30) Foreign Application Priority Data
Jan. 22, 2003 (GB) 0301469.3

(51) Int. Cl. H04N 7/173; G06F 3/00; G06F 13/00; H04N 7/16; H04N 5/445

(52) U.S. Cl. 725/136; 725/144; 725/114; 725/134; 725/39

(57) ABSTRACT

The invention relates to a method of transmitting a series of television programmes and a method of transmitting and receiving a television programme including interactive content, along with associated apparatus. In particular, there is provided a method of broadcasting a series of television programmes, the method comprising repeatedly broadcasting a subsequent group of programmes in the series instead of the previous group of programmes, wherein the subsequent group of programmes includes at least one programme later in the series than the programs in the previously broadcast group, and continuing in the same way in order to broadcast all of the programmes in the series. Consequently, television programmes of a series can be broadcast in groups. This method is particularly suited to broadcasting educational programmes as they provide flexibility in viewing times to encourage viewer participation.

This invention relates to methods and apparatus for transmitting and receiving television signals and, in particular, to an improved method of transmitting a series of television programmes and an improved method of transmitting and receiving a television programme including interactive content, along with associated apparatus.

Conventionally, television programmes each comprise a stream of audiovisual data and are broadcast one after the other in television channels, such as Sky One™, Sky Sports™ etc. However, digital television broadcasting now allows television networks to broadcast television programmes including several streams of audiovisual data and viewers may be able to select which of the audiovisual data streams they wish to view. Furthermore, digital television broadcasting now allows television networks to be able to carry many more channels or, in other words, to broadcast many more television programmes than previously possible by analogue television broadcasting. For example, both cable and satellite digital television networks can broadcast several hundred television programmes or audiovisual data streams at once.

One way in which television networks have used this facility is to broadcast certain television programmes, such as recently released films, on a so-called Near Video on Demand (NVOD) basis. This involves broadcasting the same television programme in different channels or in different audiovisual data streams at times offset from one another. For example, a two hour television programme may be repeatedly broadcast in eight different channels with fifteen minutes offset between broadcast of the television programme in each channel. Thus, a viewer will at most have to wait for fifteen minutes before being able to start watching the television programme from the beginning. This is clearly convenient for viewers, but NVOD requires too much broadcast capacity for it to be used for more than a few television programmes. Even with the comparatively large broadcast capacity provided by current digital satellite and cable television networks, it is impossible to operate NVOD for more than a few television programmes broadcast on a television network. Indeed, as broadcast capacity is a relatively precious commodity, it is only commercially viable to implement NVOD for premium services such as television programmes broadcast on a “pay-per-view” basis.

According to one aspect of the present invention, there is therefore provided a method of broadcasting a series of television programmes, the method comprising repeatedly broadcasting a group of programmes in the series and, after a period, repeatedly broadcasting a subsequent group of programmes in the series instead of the previous group of programmes, wherein the subsequent group of programmes includes at least one programme later in the series than the programmes in the previously broadcast group, and continuing in the same way in order to broadcast all of the programmes in the series.

According to another aspect of the present invention there is provided an apparatus for broadcasting a series of television programmes, the apparatus comprising: a transmitter for repeatedly broadcasting a group of programmes in the series and, after a given period, repeatedly broadcasting a subsequent group of programmes in the series instead of the previous group of programmes; and a controller for including in the subsequent group of programmes at least one programme later in the series than the programmes in the previously broadcast group, wherein the transmitter and controller continue in the same way in order to broadcast all of the programmes in the series.

Consequently, television programmes of a series, such as the episodes of a serial or an educational course, can be broadcast in groups, e.g. a few at a time. This provides a viewer with a selection of the programmes of the series to view during a period, e.g. the programmes in the group currently being broadcast, whilst limiting the number of programmes that are broadcast during any period. For example, the first three programmes in a series of ten programmes may be broadcast for a week, the second, third and fourth programmes in the series may be broadcast for the next week, the third, fourth and fifth programmes in the series may be broadcast for the next week and so on for eight weeks such that all ten programmes are broadcast. As the viewer will prefer to watch programmes in the series in order, the progression of choice is useful for the viewer. At the same time, there is a significant saving in broadcast capacity in comparison to conventional NVOD by which say ten channels may be continually used to broadcast all ten programmes in the series.

The groups of programmes may be broadcast as desired. For example, all of the programmes in a group may be broadcast simultaneously. However, it is preferred that the programmes in a group are broadcast one after the other or following on from each other. This reduces the broadcast capacity required to broadcast the group of programmes. For example, (all of) the programmes may be broadcast (only) in a single channel. In particular, the programmes may be broadcast as a single stream of audiovisual data, e.g. when each of the programmes in the series comprises just one stream of audiovisual data.

It is also preferred that the period is long enough for the programmes in the groups to be broadcast more than once. For example, the period may be one day or one week and the programmes might each be 30 minutes or 1 hour long. The programmes in a group might then be broadcast circularly, e.g. when all the programmes in a group have been broadcast, they may (all) be broadcast again, starting from first or earliest programme in the group and so on.

The programmes may be divided amongst the groups in a variety of ways. For example, each group of programmes may include an exclusive set of programmes in the series. More specifically, a first group might include programmes one to three in the series, a second group might include programmes four to six in the series and so on. However, it is preferred that each group of programmes includes all but the earliest (e.g. one or two) of the programmes in the preceding group of programmes and/or all but the latest (e.g. one or two) of the programmes in the succeeding group of programmes. For example, a first group of programmes may include the first, second and third programmes in the series, the second group of programmes may include the second, third and fourth programmes in a series, the third group of programmes may include the third, fourth and fifth programmes in a series and so on.

Whilst the broadcast of the programmes, e.g. each group of programmes, might be continuous, this is not required. It is envisaged that the groups of programmes may be broadcast (only) in (multiple) intervals. The intervals may be spaced from one another as desired. For example, each group of programmes might be broadcast for one week, but only between say 6 pm and 12 pm. This further reduces the required broadcast capacity, whilst not unduly limiting choice for viewers. Similarly, each group of programmes may be broadcast only at night, say between 10 pm and 5:30 am. This is useful for programmes that include adult content, such as a “better sex” course.

The above method and apparatus are particularly suited to broadcasting educational programmes as they provide flexibility in viewing times to encourage viewers to participate, whilst encouraging viewers to advance through a course. Each programme in the series might therefore be an instalment of an educational course, e.g. a lecture or course segment. In particular, it is preferred that the television programmes include interactive content as this encourages viewers to learn.

Various methods of transmitting television programmes including interactive content have been devised. For example, the applicants' international patent application number WO97/23997 describes broadcasting information data and audiovisual data in television signals to a television receiver. The television receiver outputs an interactive image for display on a television screen based on the information data and the audiovisual data. A viewer can then interact with the interactive image using a remote control and the television receiver connects to a remote site over a telephone line based on the viewer's interaction. Data can then be sent to the television receiver from the remote site. However, display of the interactive content is not dependent on or synchronised with the content of the audiovisual data.

U.S. Pat. No. 5,818,441 similarly describes transmitting audiovisual data and associated data in television signals to a television receiver. The associated data can include commands for the receiver to display a page of information as part of a television programme that is being viewed. However, the method described in this document requires a complex receiver capable of decoding interleaved audiovisual and associated data of arbitrary format. Furthermore, as the commands are sent as part of the associated data, it is difficult to transmit commands at the exact times it is desired to display the pages of information. All of the associated data would need to be accurately synchronised with the audiovisual data to transmit the commands at the desired times.

According to another aspect of the present invention, there is therefore provided a method of transmitting a television programme including interactive content, the method comprising transmitting a stream of audiovisual data for display by a receiver and transmitting a separate stream of interactive content data for storage at the receiver, wherein the stream of audiovisual data includes codes in response to the receipt of which the receiver is intended to include the stored interactive content data in the display of the audiovisual data.

According to another aspect of the present invention there is provided an apparatus for transmitting a television programme including interactive content, the apparatus comprising a transmitter for transmitting a stream of audiovisual data for display by a receiver and transmitting a separate stream of interactive content data for storage at the receiver, and an encoder for including codes in the stream of audiovisual data, in response to the receipt of which codes the receiver is intended to include the stored interactive content data in the display of the audiovisual data.

According to another aspect of the present invention, there is provided a method of receiving a television programme including interactive content, the method comprising receiving a stream of audiovisual data for display and receiving a separate stream of interactive content data, storing the interactive content data and responding to codes in the stream of audiovisual data to include the stored interactive content data in the display of the audiovisual data.

According to another aspect of the present invention, there is provided an apparatus for receiving a television programme including interactive content, the apparatus comprising a receiver for receiving a stream of audiovisual data for display and receiving a separate stream of interactive content data, a memory for storing the interactive content data and a decoder for responding to codes in the audiovisual data to include the stored interactive content data in the display of the audiovisual data.

In other words, data for interactive content can be sent separately, e.g. independently, to data for the conventional audiovisual content of a television programme. For example, the stream of interactive content data may be transmitted as data packets identified as interactive content data packets. Large amounts of interactive content can therefore be transmitted, limited only by the bandwidth available in the channel in which the data is transmitted. In contrast, the codes or commands that cause the interactive content data to be displayed can be included in the audiovisual data stream. Thus, it is straightforward to synchronise display of the information data with the audiovisual data. The above methods and apparatus are therefore more practical and straightforward to implement and more robust in use than previous methods and apparatus.

The codes may take any suitable form. However, it is preferred that they are very brief, comprising a few bytes of data for example. This has the advantage that the codes do not take up any significant broadcast capacity in the audiovisual data stream.

It is particularly preferred that the codes are transmitted in a Vertical Blanking Interval (VBI) of the audiovisual data stream. The VBI is a section of an audiovisual data stream at the beginning of each frame of video that is not used for picture content and not displayed in the common Phase Alternation Line (PAL) and National Television System Committee (NTSC) television signal formats. For example, in the NTSC format, the VBI comprises the first 21 lines of 525 raster lines of each video frame.

U.S. Pat. No. 5,818,441 describes the transmission of associated data in the VBI. However, the VBI is conventionally used to transmit subtitles and Teletext™ data (see, e.g. European Telecommunications Standards Institute (ETSI) standards EN 300706 v1.2.1 (2002-12) “Enhanced Teletext Specification” and EN 300472 v1.2.2 (1997-08) “Digital Video Broadcasting DVB; specification for conveying ITU-R System B Teletext in DVB bitstreams”). The method described in U.S. Pat. No. 5,818,441 is therefore incompatible with the conventional transmission of subtitles and Teletext™ data, which is undesirable. Furthermore, the amount of associated data transmitted by the system of U.S. Pat. No. 5,818,441 is limited by the capacity of the VBI as all of the associated data is transmitted in the VBI.

In contrast, the present invention provides flexibility in the amount of information data that is transmitted and hence the type of interactive content. Similarly, the applicants have recognised that, whilst most of VBI is taken up by subtitles and Teletext™ data, some parts of the VBI are not used by conventional systems. The codes may therefore be transmitted in a part of the VBI that is not used to transmit subtitles and Teletext™ data. This has the advantage that existing subtitle and Teletext™ services can continue to be provided.

The VBI is conventionally divided into a number of pages by transmitting data with headers identifying different pages of data. A magazine address can have a value from 0 to 7 corresponding to the hundreds digit of a page numbers from 100 to 800. A page address can have a hexadecimal value from 00 to FF corresponding to the last two digits of the page number. It is particularly preferred that the codes of the above method and apparatus are transmitted in a page of Teletext™ data. Using the VBI in this way is particularly straightforward and convenient to implement, as present receivers are adapted to decode such pages of data from the VBI. Furthermore, carrying out the insertion of codes into a page of Teletext™ data in the VBI is convenient as existing editing and broadcast systems are capable of inserting information in this way in the VBI. It is particularly preferred that the codes are transmitted in a page having address 7 AA, which is not presently used.

Another advantage of the above method and apparatus is that the VBI is inherently received with the audiovisual data on a frame by frame basis. It is therefore straightforward to synchonise display of the interactive content and the audiovisual data to within a few frames of the video of the audiovisual data. The display of the interactive content can therefore be merged seamlessly with the display of the audiovisual data In particular, it is therefore a preferred feature of the present invention to include the interactive content represented by the stored information data in the display of the audiovisual data by overlaying the interactive content on the audiovisual data. The interactive content may also be varied in response to the receipt of further codes in the audiovisual data stream.

Where the television programme(s) is/are of an educational nature, as mentioned above, it is preferable that the interactive content comprises questions and answers. In other words, the information data may comprise graphics defining questions and answers for display with the audiovisual data. Allowing a viewer to answer questions during a programme is considered to provide improved learning in comparison to passively viewing a television programme.

The questions might be of a multiple choice nature, i.e. a choice of answers to each question may be displayed with the questions. The viewers' answers to the questions may be stored by the receiver and used to offer the viewer further interactive opportunities. In particular, it is preferred that the receiver can connect to a remote server and transmit data representing the viewers' answers and/or other personal data to the remote server. The remote server can then cooperate with the receiver to provide the viewer with personal interactive content.

Examples of the present invention will now be described with reference to the accompanying drawings, in which:

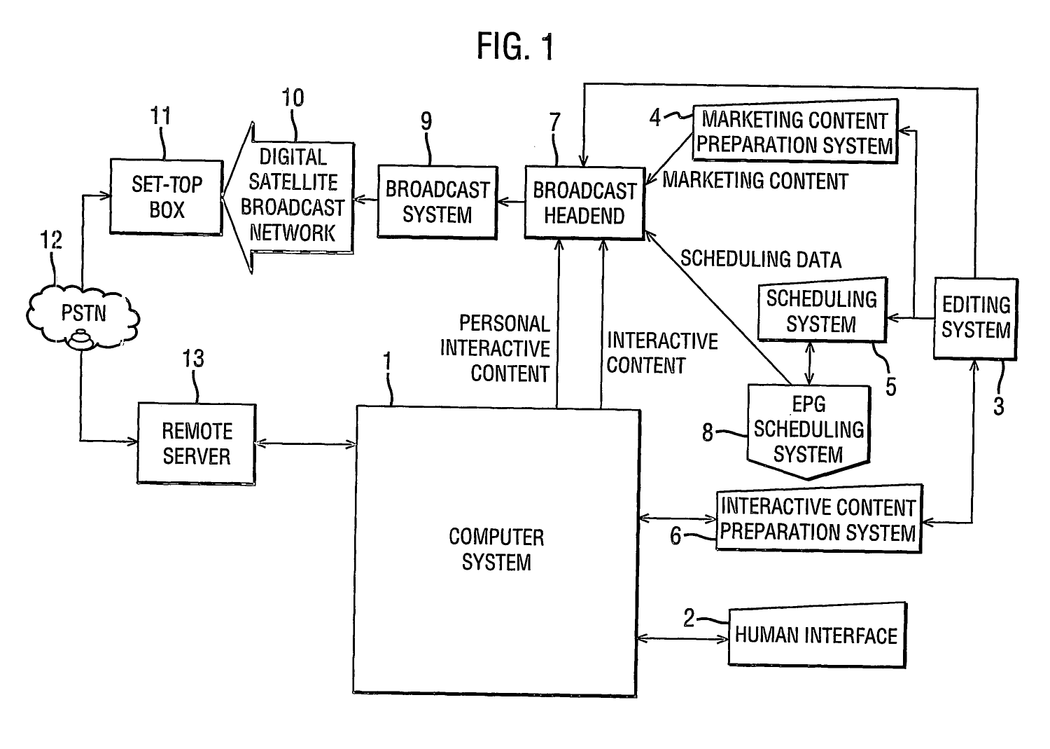

FIG. 1 is a schematic illustration of a system for providing interactive learning;

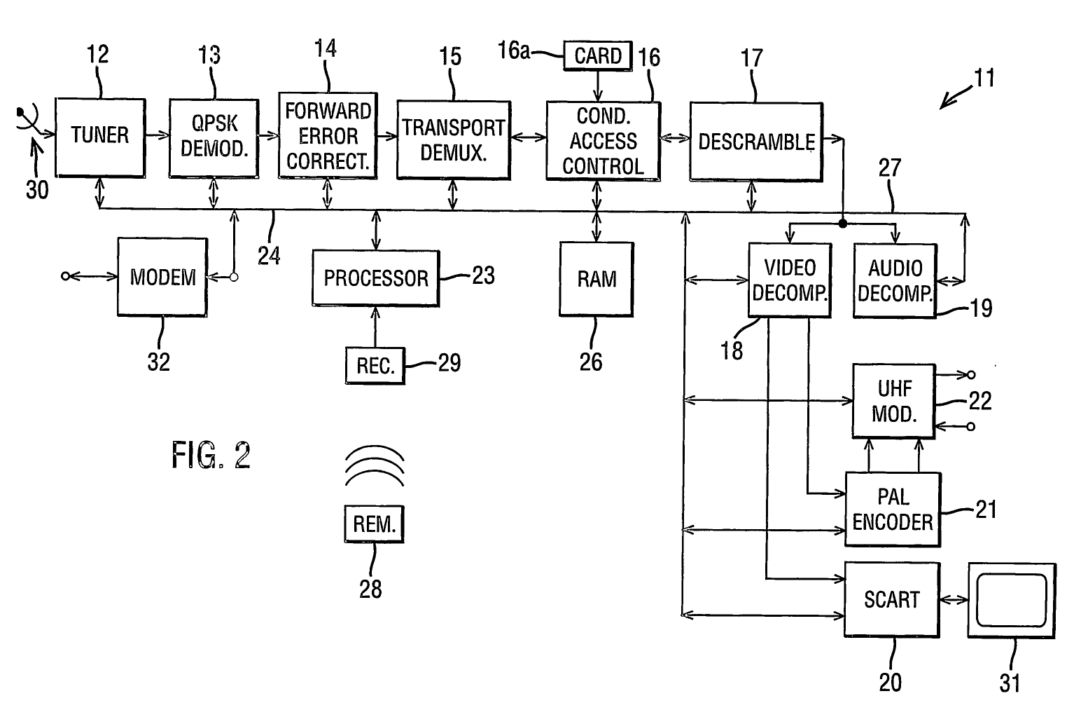

FIG. 2 is an illustration of a set top box for receiving satellite television signals;

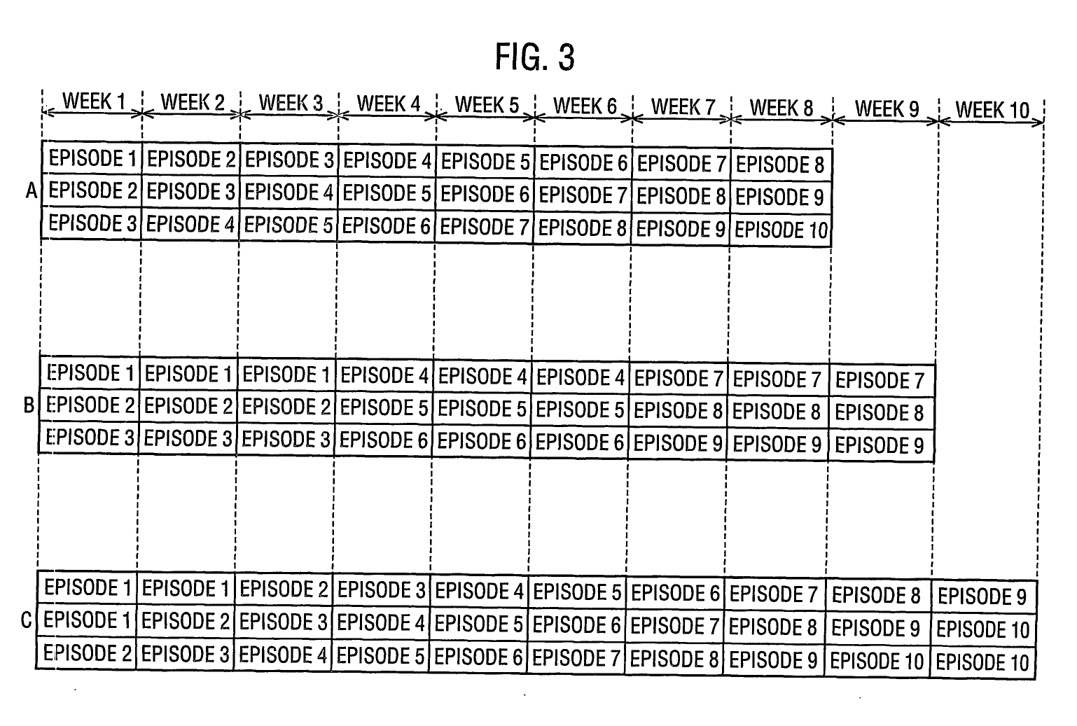

FIG. 3 is a graphical representation of three television schedules for television programmes produced by the interactive learning system;

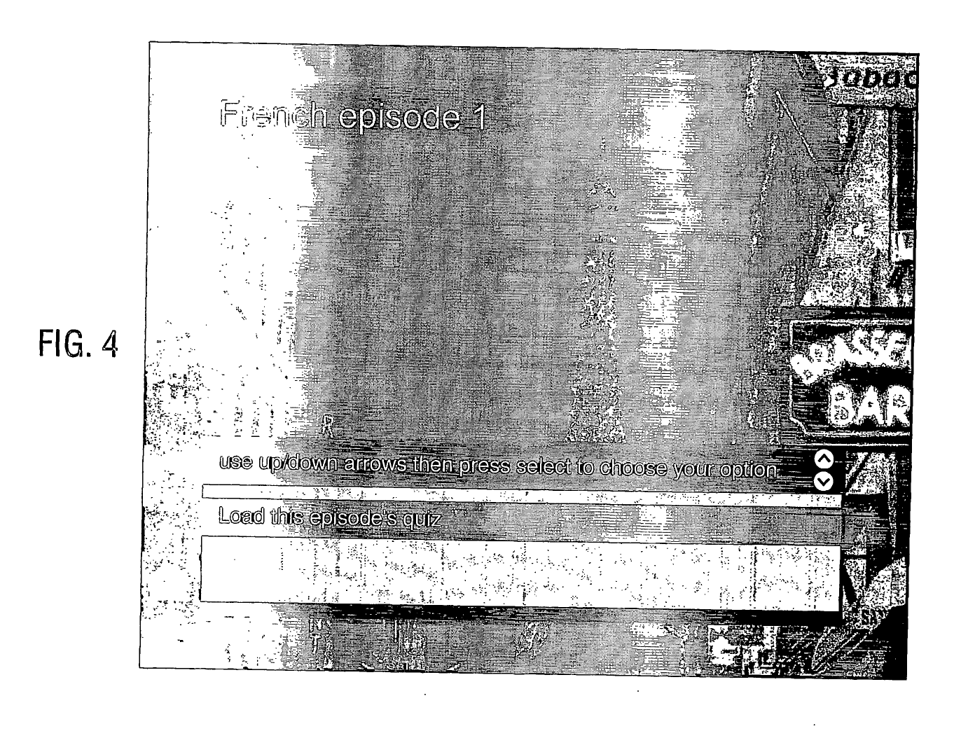

FIG. 4 is a representation of a display by which interactive content of the television programmes can be accessed;

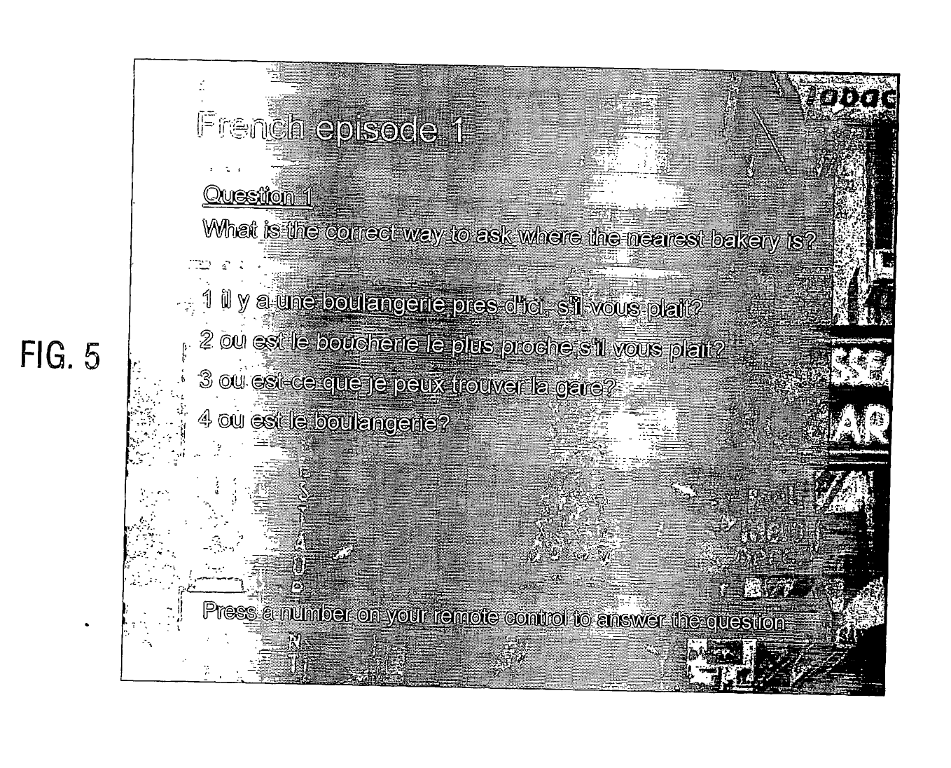

FIG. 5 is a representation of a display of interactive content; and

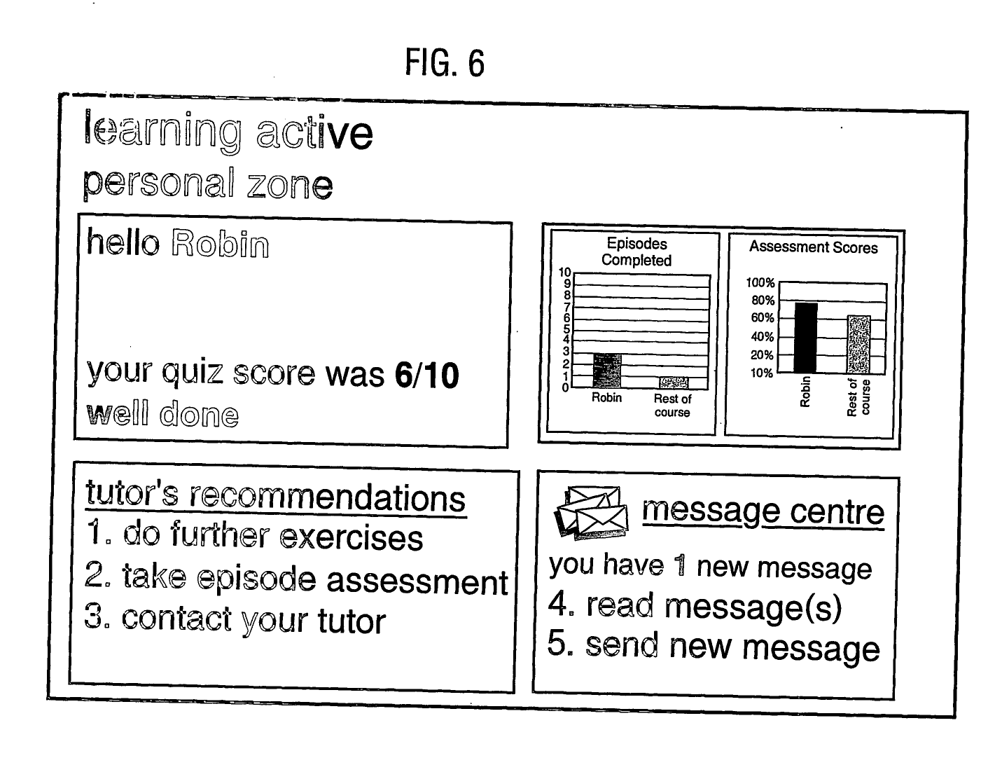

FIG. 6 is a representation of a display of personalised interactive content.

Referring to FIG. 1, a computer system 1 manages a system for providing interactive learning in which television programmes including interactive content are delivered to television receivers (e.g. a set top box 11) at consumer locations via a digital satellite broadcast network 10. The set top box 11 allows consumers to communicate with the system over a Public Switched Telephone Network (PSTN) 12.

The computer system 1 has a human interface 2 by which an operator can vary the way in which the computer system 1 manages the interactive learning system and can input data for management of the interactive learning system as appropriate. Audiovisual editing system 3 is connectable to the computer system 1 to provide edited audiovisual data captured by video cameras and such like (not shown). More specifically, the audiovisual editing system 3 is connectable to an interactive content preparation system 6, which in turn is connected to the computer system 1. The editing system 3 is also connected to a marketing content preparation system 4, a scheduling data system 5 and a broadcast head end 7.

The interactive content preparation system 6 is an editing system for preparing interactive content, which comprises interactive images including graphics and text, defining questions and answers in this example. The interactive content preparation system 6 is connected to the computer system 1 to output the prepared interactive content to the computer system 1. A return path from the computer system 1 to the interactive content preparation system 6 and editing system 3 is also provided so that the computer system 1 and interactive content preparation system 6 can provide codes for insertion in the audiovisual data stream by the editing system 3 as discussed in more detail below. The computer system 1 is connected to the head end 7 to transmit the interactive content to the head end 7.

The marketing content preparation system 4 is an editing system for preparing marketing content, which comprises advertising images including still pictures, video and text in this example. The marketing content preparation system is connected to the broadcast head end 7 to output the marketing content to the broadcast head end 7 for broadcast over the network 10.

The scheduling system 5 is capable of preparing a schedule of times at which television programmes represented by the audiovisual data are to be broadcast. The scheduling data system 5 is connected, in turn, to an Electronic Programme Guide (EPG) scheduling system 8 to output date and time data representing the schedule to the EPG scheduling system 8. The EPG scheduling system 8 receives the date and time data from the scheduling data system 5 and other similar scheduling systems (not shown) and is arranged to prepare a complete schedule of all television programmes to be broadcast over the digital satellite broadcast network 10. The EPG scheduling system 8 is connected to the broadcast head end 7 to provide the broadcast head end 7 with the scheduling data representing the complete schedule.

The broadcast head end 7 is arranged to broadcast the marketing content, interactive content and audiovisual data using the scheduling data and instructions from the computer system 1. The broadcast head end 7 is arranged to output the marketing content, interactive content and audiovisual data as a data stream or streams, to a broadcasting system 9, which in turn is arranged to broadcast the data stream(s) over the digital satellite television network 10 to the set top box 11, which is usually located in a home.

The set top box 11 is arranged to receive the data stream(s) and process them as described in more detail below. It is also connectable via the PSTN 12 to a remote server 13 that cooperates with the computer system 1 to receive personal data from the set top box 11. The server 13 is arranged to and transmit personal interactive content to the set top box 11 both via the PSTN 12 and via the digital satellite television network 10.

In more detail, referring to FIG. 2, the set top box 11 comprises a tuner 12 for receiving the data stream(s) as satellite television signals from the satellite network 10 via a satellite antenna 30. The tuner 12 is connected to output the received signals to a Quadrature Phase Shift Key (QPSK) demodulator 13, which demodulates the received signals. The QPSK demodulator 13 is connected to output the demodulated signals to a forward error correction circuit 14 for error correcting the demodulated signals. The forward error correction circuit 14 is connected to output the corrected signals to a demultiplexer 15 for separating the signals into a video data stream, an audio data stream and an information data stream.

Satellite and cable television programmes are usually scrambled to prevent unauthorised access by non-authorised users. The set top box 11 therefore has a conditional access control circuit 16 that cooperates with a smart card reader 16a to determine whether or not a viewer is authorised to view the received signals. The conditional access control circuit is arranged to allow the video, audio and information streams to be output to a scrambling circuit 17 for descrambling the received signals if a viewer is authorised to view the received signals. The descrambling circuit 17 is arranged to output the descrambled video stream and audio stream to a video decompression circuit 18 and audio decompression circuit 19 respectively that are able to decompress the video and audio streams and output them to television 31 via Phase Alternation Line (PAL) encoder 21 and Ultra High Frequency (UHF) modulator 22 or via Syndicat des Constructeurs d'Appareils Radiorécepteurs et Téléviseurs (SCART) interface 20. The descrambling circuit is also arranged to output the descrambled information data stream to a processor 23 connected to the various components of the set top box 11 via a data bus 27 and a random access memory (RAM) 26 for storage.

The bus 27 connects the processor 23 to a modem 32 of the set top box 11. The modem 32 allows communication via the PSTN 12 with remote server 13. The processor 23 is also connected to a receiver 29 for receiving signals from a remote control 28.

Returning to FIG. 1, the editing system 3 provides audiovisual data representing a series of television programmes, which might comprise say ten programmes, each thirty minutes long to the broadcast head end 7, marketing content preparation system 4, scheduling system 5 and interactive content preparation system 6. In this example, the television programmes are each episodes of a French course. The scheduling system 5 and EPG scheduling system 8 allocate dates and times at which each programme in the series is to be broadcast. More specifically, the scheduling system 5 requests the EPG scheduling system 8 to schedule say the first three programmes of the series in turn one after the after circularly 24 hours per day for one week on one channel. The EPG scheduling system 8 compares this request with requests from scheduling systems from other channels and, provided there is sufficient broadcasting capacity, adds the programmes to the EPG schedule and outputs scheduling data defining the dates and times at which each programme is to be broadcast by the broadcast head end 7. The scheduling system 5 requests the EPG scheduling system 8 to schedule all programmes in the series in a similar way.

More specifically, in a first example, illustrated as schedule A in FIG. 3, the scheduling system 5 requests the EPG scheduling system 8 to schedule programmes one, two and three of the series for broadcast one after the other, circularly, in one channel, for a first week. The scheduling system 5 also requests the EPG to schedule programmes two, three and four of the series for broadcast one after the other circularly in one channel for a second week, immediately following the first week, and so on until week eight, in which episodes eight, nine and ten are broadcast one after the other circularly for the eighth week in one channel such that all of the programmes in the series are broadcast.

In a second example, illustrated as schedule B in FIG. 3, the scheduling system 5 requests the EPG scheduling system 8 to schedule the first, second and third programmes for broadcast one after the other circularly for three weeks in one channel. It also requests the EPG scheduling system 8 to schedule the fourth, fifth and sixth programmes of the series circularly one after the other for three weeks in the one channel for the following three weeks. Finally, the scheduling system requests the EPG scheduling system to schedule the seventh, eighth and ninth programmes in the series one after the other circularly for the next following three weeks. Thus, all of the programmes in the series are broadcast over a nine week period.

In a third example, illustrated as schedule C in FIG. 3, the scheduling system 5 requests the EPG scheduling system 8 to schedule the first programme twice followed by the second programme once for repeated broadcast in one channel for a first week. The scheduling system 5 also requests that the first, second and third programmes be broadcast one after the other, circularly, in one channel for a second week, immediately following the first week. It then requests that the second, third and fourth programmes be broadcast one after the other, circularly, in one channel for a third week, immediately following the second week, and so on until the tenth week in which it requests that the ninth programme is broadcast once followed by the tenth programme twice repeatedly in one channel. Schedule C has the advantage that a ten programme series is broadcast over ten weeks as a viewer might expect.

The marketing content preparation system 6 prepares pages of graphics setting out information on each series of television programmes. In this example, one page of graphics, including a short video clip, introduces the French course and provides a link to further information. Other pages of graphics set out further information including programme times, costs and payment options etc. The marketing content is incorporated as an interactive service as described in the applicant's international patent application number WO 97/23997 for example.

The interactive content produced by interactive content preparation system 6 comprises pages of graphics and text setting out questions and answers related to the content of the television programmes. The computer system 1 transmits the interactive content it receives from the interactive content preparation system 6 to the broadcast head end 7 for storage and subsequent transmission to the set top box 11. The computer system 1 requests the broadcast head end 7 to transmit the interactive content to the set top box 11 at around the beginning of the programme to which it is related.

As the computer system 1 receives the interactive content prepared by the interactive content preparation system 6, it allocates a time in the audiovisual data stream at which the questions, answers or other pages of graphics should be displayed. These times are output to the interactive content preparation system 6, which prepares codes for insertion in the Vertical Blanking Interval (VBI) of the audiovisual data stream, which codes identify the respective pages of graphics to be displayed. The interactive content preparation system 6 outputs the codes to the editing system 3 for insertion in the audiovisual data stream at the time specified by the computer system 1 for the display of the respective pages of graphics and the audiovisual editing system 3 inserts the codes in the VBI of the audiovisual data stream.

In this example, the codes are inserted in the audiovisual data stream in Teletext™ page number 7AA. The editing system (3) then outputs the audiovisual data stream to the broadcast head end 7 where it is stored for broadcast at the times specified by the complete schedule.

The editing system 3 can optionally include other data in the VBI of the audiovisual data stream. As described in European Telecommunication Standards Institute (ETSI) standard EN 300706 v1.2.1 (2002-12) “Enhanced Teletext Specificiation” and ETSI standard EN 300472 v1.2.2 (1997-08) “Digital Video Broadcasting (DVB); Specification for Conveying ITU-R System B Teletext in DVB Bitstreams”, Teletext™ data, including subtitle data, is inserted in the VBI of an analogue audiovisual data stream as pages of data. In another example, Teletext™ data is supplied by other sources (not shown) and added to the audiovisual data stream at the head end 9.

The head end 9 outputs the audiovisual data stream and interactive content in the same channel or, more specifically, as one Digital Video Broadcast (DVB) service. The output signals comprise a video stream, an audio stream and an information data stream. The information data stream comprises Teletext™ data packets, subtitle data packets and interactive content data packets.

The descrambler 17 of the set top box 11 outputs the received video stream and audio stream to the video decompressor 18 and audio decompressor 19 respectively for display on television 31. The information data stream is output to processor 23, which directs interactive content data packets to the RAM 26 for storage. Teletext™ data packets are directed to the video decompressor 18 for insertion into the VBI of the audiovisual data stream displayed on the television 31. Teletext™ data can therefore be utilised by the television 31 in a conventional manner.

In this example, subtitle data packets are output for display by the processor 23 using interactive services software. Similarly, codes included in Teletext page 7AA are identified by the processor 23 using interactive services software. More specifically, the processor 23 responds to receipt of a code in page 7AA by retrieving stored interactive content data identified by the code, e.g. a page of graphics, and including it in the display of audiovisual data.

In one example, when a viewer starts to watch a television programme in the series, the set top box 11 displays the audiovisual data stream on the television 31 via the PAL encoder 21 and UHF modulator 22 or via the SCART connection 20 depending on how the television 31 is connected to the set top box 11. After a time determined by the computer system 1, the audiovisual data stored at the head end 9 includes a first code in Teletext™ page 7AA indicating that a first page of interactive content should be displayed. When this first code is received by the set top box 11 the first page of interactive content is displayed. In this example, this comprises a prompt asking a viewer whether they would like to complete a quiz associated with the programme, as shown in FIG. 4. This is displayed by the processor 23 retrieving the page of graphics from the interactive content stored in the RAM 26 and outputting it to the television 31 via the PAL encoder 21 and UHF modulator 22 or SCART connection 20 as appropriate. If the viewer does not respond, the page of graphics ceases to be displayed and the processor 23 ignores codes received in Teletext™ page 7AA for the duration of the programme. The set top box 11 therefore displays only the received audiovisual data. If the viewer chooses to complete the quiz, by manipulating buttons on the remote control 28 to communicate with the processor 23 via the receiver 29, the processor 23 is activated to process the stored interactive content corresponding to the viewed programme in accordance with the received codes.

In the latter case, when the processor 23 identifies that a second code is received in Teletext™ page 7AA, the processor 23 displays a page of graphics representing question 1 of the quiz and asking the viewer to press a button on the remote control 28 to answer the question. When the viewer presses the correct button on the remote control 28, the processor 23 displays a further page of graphics indicating that the viewer is correct. When the viewer presses an incorrect button on the remote control 28, the processor 23 displays a further page of graphics indicating that the viewer is incorrect. If the viewer does not respond after a predetermined period, the processor 23 displays a further page of graphics indicating that the time for answering the question has expired and displaying the answer to the question. After another predetermined period from the time that the question is first displayed, all pages of graphics cease to be displayed. Only the audiovisual data is then displayed for a period. When a third code is then received in Teletext™ page 7AA a second question is displayed and so on. Typically, there may be ten questions associated with a programme.

The processor 23 stores the viewer's answers to each of the questions in the RAM 26. At the end of the programme, when the processor identifies that another code is received in Teletext™ page 7AA, a page of graphics inviting the viewer to enter a “personal learning zone” is displayed. If the viewer responds positively by manipulating the remote control 28 to select “yes” on the page, the processor 23 causes the modem 32 to connect with the remoter server 13 over Public Switched Telephone Network (PSTN) 12.

Once a connection is established, the processor 23 retrieves data representing the viewer's answers to the quiz from the RAM 26 and transmits it to the remote server 13. In response, the remote server transmits a page of information, as illustrated in FIG. 6, for display by the set top box 11. In this example, the remote server 13 use Wireless Mark-up Language (WML) to generate the page of information. As seen in FIG. 11, the page of information includes the viewer's quiz score, statistics on previous quiz results and viewing history, recommendations for further study and a link to personal messages held on the server 13.

Examples of the invention are described above with reference to an interactive learning system delivered by digital satellite broadcast and dial-up networking. However, various aspects of the invention are applicable more broadly, for example, to schedule series of entertainment programmes or to deliver interactive content for advertising or home shopping. Similarly, various aspects of the invention may be implemented using terrestrial digital or analogue television broadcast, cable television broadcast or such like and communication between a receiver and the computer system 1 might be over the Internet or by cable modem for example.

1. A method of broadcasting a series of television programmes, the method comprising repeatedly broadcasting a group of programmes in the series and, after a period, repeatedly broadcasting a subsequent group of programmes in the series instead of the previous group of programmes, wherein the subsequent group of programmes includes at least one programme later in the series than the programmes in the previously broadcast group, and continuing in the same way in order to broadcast all of the programmes in the series.

2. The method of claim 1, wherein repeatedly broadcasting the group (or subsequent group) of programmes comprises broadcasting the programme in a single channel or audiovisual data stream.

3. The method of claim 1, wherein repeatedly broadcasting the group (or subsequent group) of programmes comprises broadcasting the programmes in the group one after the other.

4. The method of claim 1, wherein repeatedly broadcasting the group (or subsequent group) of programmes comprises broadcasting the programmes only one at a time.

5. The method of claim 1, wherein the period is long enough for the programmes in the groups to be broadcast more than once.

6. The method of claim 1, wherein the programmes are broadcast circularly.

7. The method of claim 1, wherein each group of programmes includes all but the earliest one of the programmes in the preceding group of programmes and/or all but the latest one of the programmes in the succeeding group of programmes.

8. The method of claim 1, wherein the groups of programmes are broadcast only during intervals.

9. A method of transmitting a television programme including interactive content, the method comprising transmitting a stream of audiovisual data for display by a receiver and transmitting a separate stream of interactive content data for storage at the receiver, wherein the stream of audiovisual data includes codes in response to the receipt of which the receiver is intended to include the stored interactive content data in the display of the audiovisual data.

10. A method of receiving a television programme including interactive content, the method comprising receiving a stream of audiovisual data for display and receiving a separate stream of interactive content data, storing the interactive content data and responding to codes in the stream of audiovisual data to include the stored interactive content data in the display of the audiovisual data.

11. The method of claim 9, wherein the interactive content is included in the display of the audiovisual data by overlaying it on the displayed audiovisual data.

12. The method of claim 9, wherein the displayed interactive content is varied in response to further codes included in the audiovisual data stream.

13. The method of claim 9, wherein the codes are transmitted a Vertical Blanking Interval (VBI) of the audiovisual data stream.

14. The method of claim 9, wherein the codes are transmitted in a page of Teletext™.

15. The method of claim 9, wherein the codes are transmitted in Teletext™ page 7AA.

16. An apparatus for broadcasting a series of television programmes, the apparatus comprising: a transmitter for repeatedly broadcasting a group of programmes in the series and, after a given period, repeatedly broadcasting a subsequent group of programmes in the series instead of the previous group of programmes; and a controller for including in the subsequent group of programmes at least one programme later in the series than the programmes in the previously broadcast group, wherein the transmitter and controller continue in the same way in order to broadcast all the programmes in the series.

17. The apparatus of claim 16, wherein the transmitter repeatedly broadcast the programmes in the group (or subsequent group) in a single channel or audiovisual data stream.

18. The apparatus of claim 16, wherein the transmitter repeatedly broadcasts the programmes in the group (or subsequent group) one after the other.

19. The apparatus of claim 16, wherein the transmitter repeatedly broadcasts the programmes in the group (or subsequent group) only one at a time.

20. The apparatus of claim 16, wherein the period is long enough for the programmes in the groups to be broadcast more than once.

21. The apparatus of claim 16, wherein the transmitter broadcasts the programmes circularly.

22. The apparatus of claim 16, wherein each group of programmes includes all but the earliest one of the programmes in the preceding group of programmes and/or all but the latest one of the programmes in the succeeding group of programmes.

23. The apparatus of claim 16, wherein the transmitter broadcasts the groups of programmes only during intervals.

24. An apparatus for transmitting a television programme including interactive content, the apparatus comprising a transmitter for transmitting a stream of audiovisual data for display by a receiver and transmitting a separate stream of interactive content data for storage at the receiver, and an encoder for including codes in the stream of audiovisual data includes, in response to the receipt of which codes the receiver is intended to include the stored interactive content data in the display of the audiovisual data.

25. An apparatus for receiving a television programme including interactive content, the apparatus comprising a receiver for receiving a stream of audiovisual data for display and receiving a separate stream of interactive content data, a memory for storing the interactive content data and a decoder for responding to codes in the audiovisual data to include the stored interactive content data in the display of the audiovisual data.

26. The apparatus of claim 24, wherein the receiver includes the interactive content in the display of the audiovisual data by overlaying it on the displayed audiovisual data.

27. The apparatus of claim 24, wherein the decoder varies the displayed interactive content in response to further codes in the audiovisual data stream.

28. The apparatus of claim 24, wherein the encoder includes the codes in a Vertical Blanking Interval (VBI) or the audiovisual data stream.

29. The apparatus of claim 24, wherein the encoder includes the codes in a page of Teletext™.

30. The apparatus of claim 24, wherein the encoder includes the codes in Teletext™ page 7AA.

31. (canceled)

32. The method of claim 2, wherein repeatedly broadcasting the group (or subsequent group) of programmes comprises broadcasting the programmes in the group one after the other.

33. The method of claim 10, wherein the interactive content is included in the display of the audiovisual data by overlaying it on the displayed audiovisual data.

34. The method of claim 10, wherein the displayed interactive content is varied in response to further codes included in the audiovisual data stream.

35. The method of claim 10, wherein the codes are transmitted a Vertical Blanking Interval (VBI) of the audiovisual data stream.

36. The method of claim 10, wherein the codes are transmitted in a page of Teletext™.

37. The method of claim 10, wherein the codes are transmitted in Teletext™ page 7AA.

38. The apparatus of claim 17, wherein the transmitter repeatedly broadcasts the programmes in the group (or subsequent group) one after the other.

39. The apparatus of claim 25, wherein the receiver includes the interactive content in the display of the audiovisual data by overlaying it on the displayed audiovisual data.

40. The apparatus of claim 25, wherein the decoder varies the displayed interactive content in response to further codes in the audiovisual data stream.

41. The apparatus of claim 25, wherein the encoder includes the codes in a Vertical Blanking Interval (VBI) or the audiovisual data stream.

42. The apparatus of claim 25, wherein the encoder includes the codes in a page of Teletext™.

43. The apparatus of claim 25, wherein the encoder includes the codes in Teletext™ page 7AA.
